(19) United States
(12) Patent Application Publication
(10) Pub. No.: US 2026/0041080 A1
(43) Pub. Date: Feb. 12, 2026

(54) LID ENTRANCE STRUCTURE FOR INSECT TRAP

(71) Applicant: Sterling International Inc., Spokane, WA (US)

(72) Inventors: Rodney G. Schneidmiller, Greenacres, WA (US); Qing-He Zhang, Greenacres, WA (US); Marc Chapin, Spokane, WA (US)

(73) Assignee: Sterling International Inc., Spokane, WA (US)

(21) Appl. No.: 19/239,225

(22) Filed: Jun. 16, 2025

Related U.S. Application Data
(60) Provisional application No. 63/680,422, filed on Aug. 7, 2024.

(51) Int. Cl. A01M 1/10; A01M 1/02

(52) U.S. Cl. CPC A01M 1/106; A01M 1/02; A01M 2200/012

(57) ABSTRACT

A lid entrance structure suitable for use with conventional reusable fly traps is disclosed. The lid entrance structure provides a connection interface between a reusable fly trap and a large container, such as a standard 5-gallon bucket. The lid entrance structure, components of the reusable fly trap, and the large container, together form a type of enlarged or outsized insect trap.

### CROSS-REFERENCE TO RELATED APPLICATION

This application claims the benefit of U.S. Provisional Patent Application No. 63/680422, filed Aug. 7, 2024, the disclosure of which is hereby incorporated by reference in its entirety.

### FIELD OF THE DISCLOSURE

The present disclosure relates to a lid entrance structure suitable for use with a conventional reusable fly trap and a large container, such as a standard 5-gallon bucket. The present disclosure also relates to insect traps formed by attaching one or more components of a conventional reusable fly trap to a large container, such as a standard 5-gallon bucket, via the lid entrance structure.

### BACKGROUND

Insects of the order Diptera, sometimes referred to as “true flies,” including house flies, horse flies, stable flies, bottle flies, flesh flies, black flies, sand flies, and mosquitoes, are often significant disease vectors, nuisances, and pests. For example, the house fly, Musca domestica L. (Diptera: Muscidae), is one of the most important hygiene pests worldwide. True flies are not only a nuisance, irritating people and animals and leaving regurgitation and fecal spots on surfaces, but they are also vectors of pathogens that may cause serious diseases in humans and animals.

Similarly, insects of the order Hymenoptera, which include flying insects such as sawflies, social wasps, and bees, are also significant nuisances and pests. Social wasps, including paper wasps, hornets, and yellowjackets, are a significant hazard to people and animals engaged in outdoor activities due to their painful and potentially deadly stings. Such flying insects can be prevalent in rural settings and in very well-developed residential areas. Pestiferous insects from other orders such as beetles (Coleoptera), moths (Lepidoptera) and stink/seed bugs (Heteroptera), flying and otherwise, are also known, for example in agricultural and greenhouse settings and in other commercial venues, including, for example, meat packing factories, food processing facilities, and livestock ranches.

Significant efforts are directed to combating the problems caused by pest insects, including the use of chemical control means such as pesticides, which may be annoying and/or harmful to persons or non-target animals. Many insects such as house flies and the like have developed resistance against commonly used insecticides due to typically high reproductive rates. Moreover, insecticides that are effective against pestiferous insects may not be an attractive option to persons having concerns regarding personal health effects, environmental effects, and the like.

As a part of environmentally sound pest control strategies, insect traps baited with semiochemicals (such as food-based kairomone attractants, insect-produced pheromone attractants etc.) for flying or walking insects have been quite successful at attracting and trapping target insects and are known in the art. For instance, many types and sizes of fly traps are commercially available. One group of the well-known fly traps are the U.S. EPA-registered RESCUE!® brand disposable and reusable fly traps for the consumer market. Due to their extremely strong trapping efficacy, many RESCUE!® fly traps can be filled up with flies within a few days if placed in high fly population areas, such as dairy, pig, chicken or other animal farms. Thus, a consumer would have to throw away the disposable fly traps or refresh the reusable fly traps very frequently during summer or warm seasons.

### SUMMARY

Instead of purchasing new disposable traps or attractant refills for reusable traps, which may be cost prohibitive, the present disclosure provides examples of large size traps (e.g., standard 5-gallon bucket) with greater trapping/holding capacity for use in agricultural, professional, and even some consumer markets. Additionally, most commercial fly traps are water-based traps where captured flies drown in the water and rot quickly in the traps, thereby requiring to be disposed in a dumpster or compost. The present disclosure provides examples of insect traps that can collect the captured flies in dry form. Thus, these dry dead flies can be used as a great source of high-quality protein for animal feed (fed directly to chickens or other poultry animals) or as a key component of feedstock mixtures.

The present disclosure provides a number of example embodiments of a lid entrance structure suitable for use with a container and a reusable insect trap. The reusable insect trap includes an insect trap cap or top and a bottle. In an embodiment, the lid entrance structure includes a top wall having an outer periphery and a tubular column having an upper section extending outwardly from the top wall and a lower section extending outwardly from the top wall in a direction opposite of the upper section. The upper section includes means for removably coupling the insect trap top of the reusable insect trap to the upper section and the lower section includes means for removably coupling the bottle of the reusable insect trap to the lower section. The lid entrance structure further includes a container connection interface extending around at least one section of the outer periphery of the top wall. The container connection interface is configured to be removably securable to the container, wherein a volume of the container is larger than a volume of the bottle.

In any embodiment, the lower section of the tubular column further includes one or more openings disposed in the sidewall of the tubular column.

In any embodiment, the volume of the container is more than three times the volume of the bottle. In another embodiment, the volume of the container is more than ten times the volume of the bottle. In yet another embodiment, the container is a standard 5-gallon bucket.

In any embodiment, the top wall of the lid entrance structure includes one or more raised annular ring. In another embodiment, the top wall of the lid entrance structure further comprising a plurality of holes formed in the one or more raised annular rings.

In any embodiment, the top wall of the lid entrance structure is at least semi-translucent for allowing light therethrough.

In another embodiment, a lid entrance structure includes a top wall having an outer periphery and a centrally disposed, tubular column having an upper section extending outwardly from the top wall. The upper section is configured to be removably coupled to a fly trap lid of a reusable fly trap. The lid entrance structure also includes a container connection interface extending in one or more sections around the outer periphery of the top wall. The container connection interface is configured to be removably affixable to a container.

In an embodiment, the tubular column also has a lower section extending outwardly from the top wall in a direction opposite of the upper section. The lower section is configured to be removably coupled to a bottle, the size of which being at least five times by volume smaller than the container.

In an embodiment, the bottle is part of the reusable fly trap.

In an embodiment, the container is a standard 5-gallon bucket.

In accordance with an aspect of the present disclosure, an insect trap is provided. The insect trap include a reusable fly trap having a fly trap cap and a collection bottle, a container that is at least five times by volume larger than the collection bottle; and an insect trap lid. In an embodiment, the insect trap lid includes a top wall having an outer periphery and a tubular column having an upper section extending outwardly from the top wall and a lower section extending outwardly from the top wall in a direction opposite of the upper section. The upper section includes means for removably coupling the fly trap cap to the upper section and the lower section includes means for removably coupling the collection bottle to the lower section. The insect trap lid further includes a container connection interface extending around at least one section of the outer periphery of the top wall, the container connection interface configured to be removably secured to the container.

In an embodiment of the insect trap, the lower section of the tubular column further includes at least one opening disposed in the sidewall of the tubular column.

In an embodiment, the insect trap further includes at least one funnel-shaped side entrance member. The at least one funnel-shaped side entrance member is coupled to the lower section of the tubular column at each location of the at least one opening.

In an embodiment, the insect trap further comprises a basket supported by the collection bottle.

In an embodiment, the insect trap further comprises an insect attractant contained in the collection bottle.

In an embodiment, the insect trap further comprises means for retaining insects within the insect trap.

### DESCRIPTION OF THE DRAWINGS

The foregoing aspects and many of the attendant advantages of the disclosed subject matter will become more readily appreciated as the same become better understood by reference to the following detailed description, when taken in conjunction with the accompanying drawings, wherein:

FIGS. 1A and 1B are front and perspective views, respectively, of one example of a conventional reusable fly trap sold commercially as the Reusable RESCUE!® Outdoor Fly Trap;

FIGS. 1C and 1D are front and perspective views, respectively, of another example of a conventional reusable fly trap sold commercially as the Reusable RESCUE!® Outdoor POP! Fly Trap;

FIGS. 2A, 2B, and 2C are perspective, cross-sectional, and detailed cross-sectional views, respectively, of one example embodiment of an insect trap formed with a lid entrance structure according to one or more embodiments of the present disclosure, a reusable fly trap, such as the reusable fly trap of FIGS. 1A-1B, and a large container, such as a standard 5-gallon bucket.

FIGS. 3A and 3B are top perspective and cross-sectional views of an example embodiment of a lid entrance structure suitable for use with an insect trap, such as the fly trap shown in FIGS. 2A, 2B, and 2C;

FIGS. 4A and 4B are right and left perspective views of one example embodiment of an optional side entrance member, such as an oval shaped side entrance member, for use with the lid entrance structure of FIGS. 3A and 3B;

FIGS. 5A and 5B are side and top perspective views, respectively, of one example embodiment of an optional basket suitable for use with an insect trap, such as the insect trap shown in FIGS. 2A, 2B, and 2C;

FIG. 6 is an exploded view of a top trap section of the insect trap of FIGS. 2A, 2B, and 2C.

FIGS. 7A and 7B are top perspective and bottom perspective views, respectively, of another example embodiment of a lid entrance structure suitable for use with an insect trap, such as the insect trap shown in FIGS. 2A, 2B, and 2C;

FIGS. 8A and 8B are top perspective and bottom perspective views, respectively, of another example embodiment of a lid entrance structure to which components of a reusable fly trap, such as the reusable fly trap of FIGS. 1A-1B, are attached, the lid entrance structure of FIGS. 8A and 8B being suitable for use with an insect trap, such as the insect trap shown in FIGS. 2A, 2B, and 2C;

FIGS. 9A and 9B are top perspective and bottom perspective views of another example embodiment of the lid entrance structure; and

FIGS. 10A and 10B are top perspective and bottom perspective views, respectively, of yet another example of a lid entrance structure suitable for use with an insect trap, such as the insect trap shown in FIGS. 2A, 2B, and 2C.

### DETAILED DESCRIPTION

The detailed description set forth above in connection with the appended drawings, where like numerals reference like elements, are intended as a description of various embodiments of the present disclosure and are not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed.

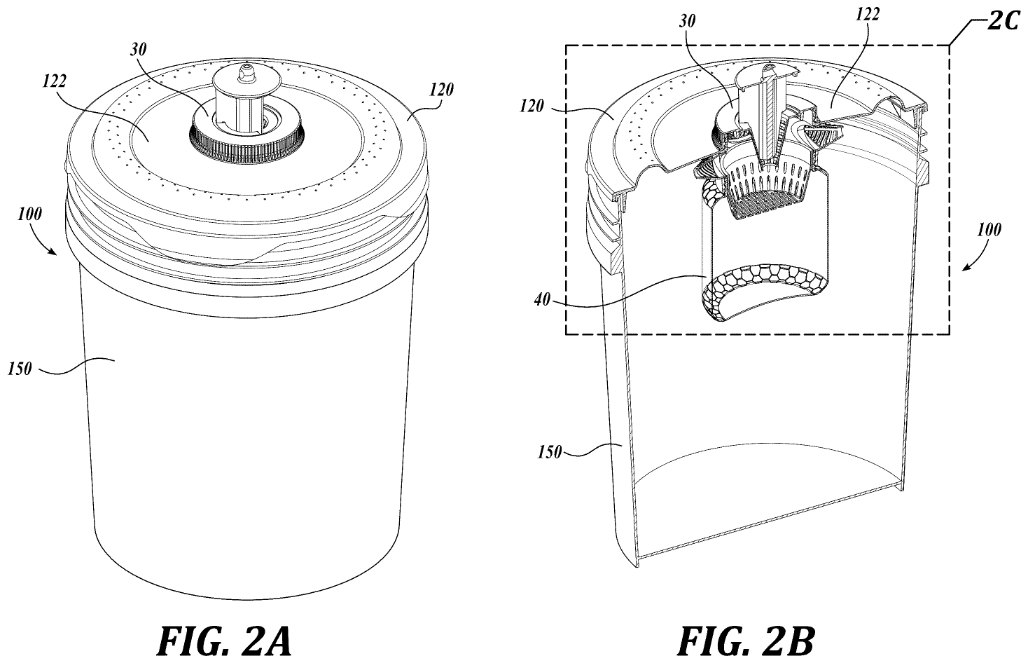

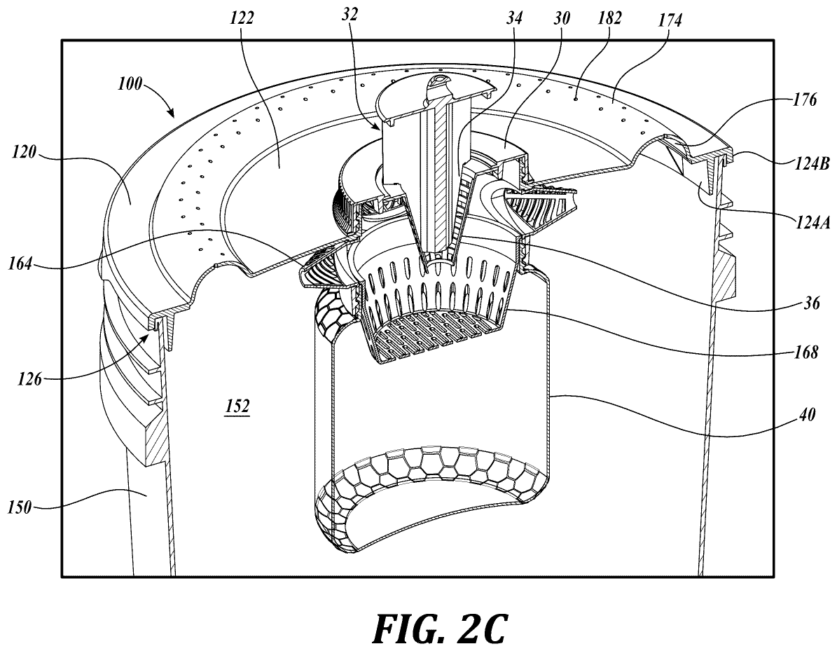

The following discussion provides examples of lid entrance structures suitable for use with conventional reusable insect traps, such as reusable fly traps. As will be described in more detail below, the lid entrance structure, sometimes referred to as an insect trap lid, provides a connection interface between a reusable insect or fly trap and a large container, such as a standard 5-gallon bucket. As will be described in more detail below, the lid entrance structure, components of the reusable insect trap, and the large container, together form a type of enlarged or outsized insect trap, an example of which is shown in FIGS. 2A, 2B, and 2C.

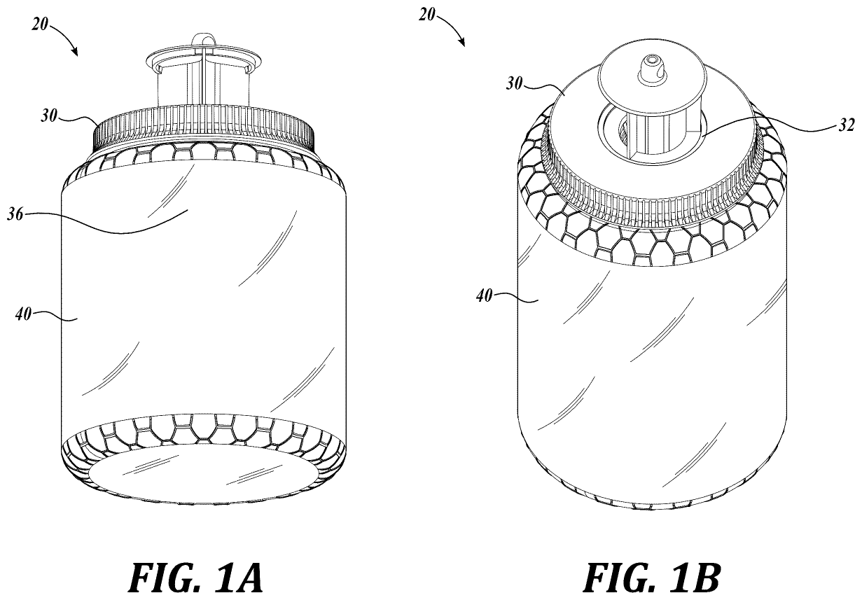

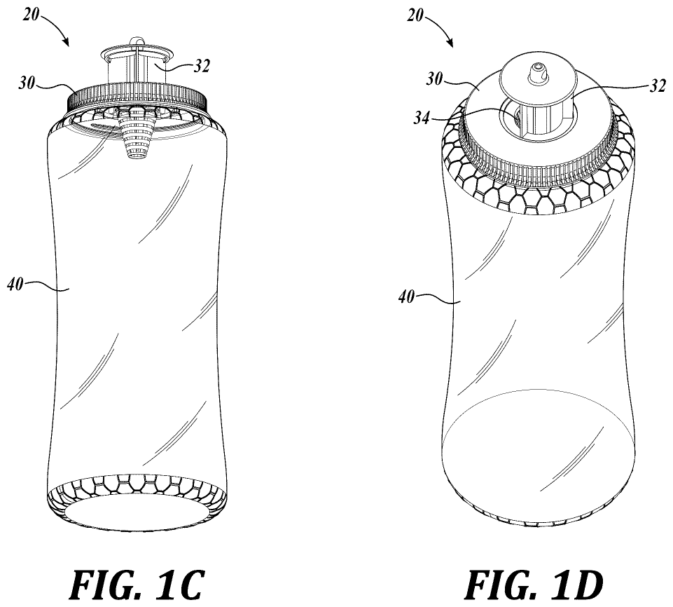

Some examples of conventional reusable fly traps are shown in FIGS. 1A and 1B and 1C and 1D, which illustrate the Reusable RESCUE!® Outdoor Fly Trap and the Reusable RESCUE!® Outdoor POP! Fly Trap, respectively. Each of these fly traps 20 include a top cap 30, sometimes referred to as a fly trap top or lid 30, configured to be threadedly attached to a bottom collection container, jar or bottle 40. The top cap 30 includes, for example, a pop-open section 32 that forms an entrance opening 34 for insect (e.g., fly, etc.) ingress. The top cap 30 and the bottle 40 can be manufactured out of any suitable material, such as plastic.

Once the flies have entered the fly trap 20 via the entrance opening 34 (See FIG. 1D) of the top cap 30 and traversed through a funnel/cone-shaped entrance structure 36 (See FIG. 1A), they collect in the bottle 40. In an embodiment, the fly trap 20 may include a fly attractant, the contents of which can be added to the bottle 40 and mixed with a liquid, such as water. In some embodiments, the fly attractant is formulated in a water-activated pouch.

FIGS. 2A, 2B, and 2C illustrate an insect trap 100 that includes an example embodiment of a lid entrance structure 120 formed in accordance with the present disclosure. As shown in FIGS. 2A, 2B, and 2C, the insect trap 100 is formed by the lid entrance structure 120, a large container 150, and components 30, 40 of a reusable insect trap, such as either one of the fly traps 20 shown in FIGS. 1A, 1B and 1C, 1D. It will be appreciated that the large container is substantially larger by volume than the bottle 40 of the reusable fly trap 20. For example, the volume of the large container can be more than 3× (i.e., three times), more than 5×, more than 10×, more than 15×, or more than 20× greater than the volume of the bottle 40. In one embodiment, the large container is a standard 5-gallon bucket.

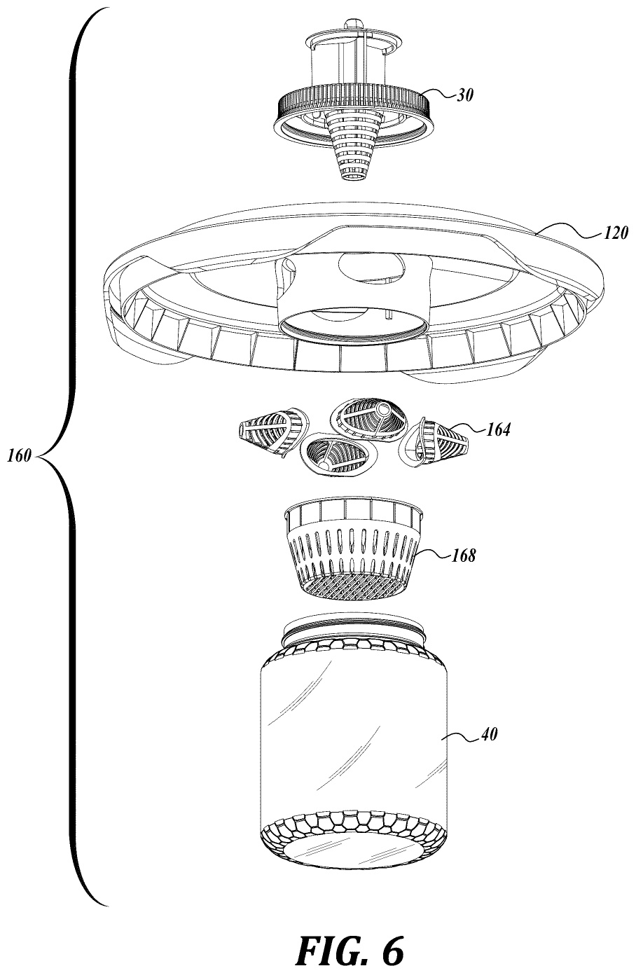

In use, the lid entrance structure 120 acts as a connection interface between the reusable fly trap 20 and the large container 150 (see FIGS. 2A-2B). In that regard, the top of the lid entrance structure 120 is configured so that a top cap of a reusable fly trap, such as top cap 30 of reusable fly trap 20, can be attached thereto to form a part of top trap section 160 (see, e.g., FIG. 6) of the insect trap 100. In some embodiments, the bottom of the lid entrance structure 120 is also configured so that a collection container, jar or bottle of a reusable fly trap, such as bottle 40 of reusable fly trap 20, can be attached thereto to form the top trap section 160 (see, e.g., FIG. 6) of the insect trap 100.

On the other hand, the bottom of the lid entrance structure 120 is configured to be removably coupled to the large container 150. For example, in the embodiment shown in FIG. 2C, the lid entrance structure 120 includes a top wall 122 with downwardly depending inner and outer flanges 124A, 124B. The flanges 124 extend around one or more sections of, or optionally, the entirety of the periphery of the lid entrance structure 120. Together with a portion of the top wall 122, the spaced apart inner and outer flanges 124A and 124B form a container connection interface 126 for removably affixing the lid entrance structure 120 to the container 150.

In an embodiment, the container connection interface 126 is sized and configured such that the lid entrance structure 120 can be snap fit, elastic/interference fit, press fit, etc., onto a standard sized 5-gallon bucket in a removable manner. While the container connection interface 126 in the embodiment shown in FIG. 2C is sized and configured to interface with the rim of a standard sized 5-gallon bucket, the container connection interface 126 may be sized and configured to be removably coupled to buckets of other shapes or to other open-ended containers of sufficient size (e.g., depth, diameter, etc.). Once coupled thereto, a suitable seal or barrier is formed between the lid entrance structure 120 and the 5-gallon bucket to block any insect egress from the bucket.

In an alternative embodiment, the container connection interface 126 may be formed with inwardly facing (female) threads for threadedly connecting to a container with cooperatingly formed (male) threads. In the example of a standard 5-gallon bucket, the outer flange 124B could extend a longer distance away from the top wall 122 and be formed with or include inwardly facing (female) threads configured for interfacing with the outer threads of a standard 5-gallon bucket. Of course, other methods and techniques may be employed in embodiments of the present disclosure for removably affixing the lid entrance structure 120 to a suitable container. It will be understood to those skilled in the art how to modify the container connection interface 126 for interfacing with these other containers. Each of these alternative technologies and configurations are within the scope of the claimed subject matter.

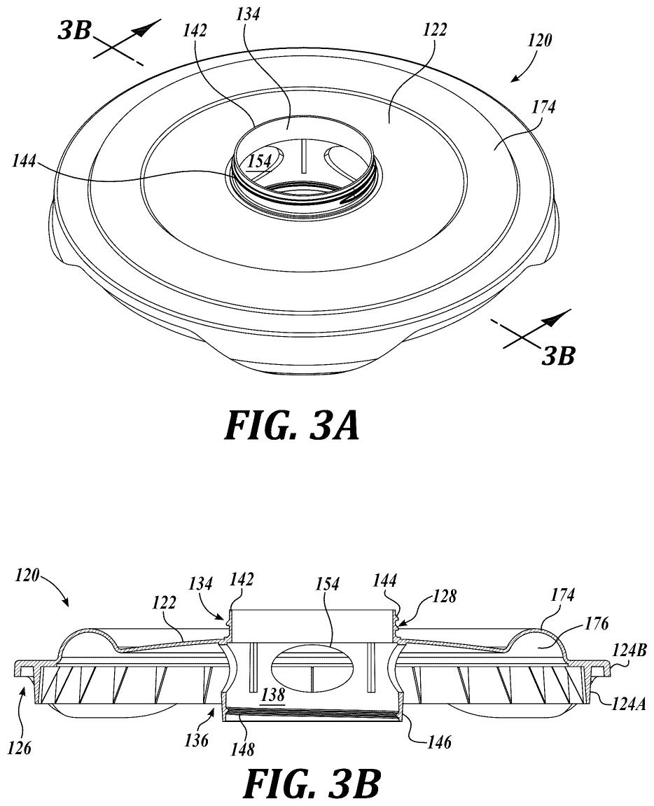

FIGS. 3A and 3B illustrate an example embodiment of the lid entrance structure 120 formed in accordance with the present disclosure. As shown in the embodiment of FIGS. 3A and 3B, the top wall 122 of the lid entrance structure 120 is generally circular and includes a container connection interface 126 at its outer periphery. Spaced apart flanges 124A and 124B of the container connection interface 126 downwardly depend from the top wall 122, as shown in FIG. 3B. In an embodiment, the lid entrance structure 120 is of unitary construction, and can be formed, for example, out of plastic via any suitable known or future developed molding techniques.

Still referring to FIG. 3B, the lid entrance structure 120 further includes a tubular column 128 configured for attachment to the one or more components of a conventional reusable fly trap, such as either of the fly traps shown in FIGS. 1A, 1B and 1C,1D. As shown in FIG. 3B, the tubular column 128 includes an upper section 134 and a lower section 136. The upper section 134 extends forwardly (e.g., upwardly) away from the top wall 122 and the lower section 136 extends rearwardly (e.g., downwardly) away from the top wall 122. In the embodiment of FIGS. 3A and 3B, the tubular column 128 is cylindrically shaped, is centrally located, and is vertically oriented with respect to center axis of the top wall 122.

As shown in FIGS. 3A and 3B, the upper section 134 of the tubular column 128 includes a top opening defined by rim 142. The upper section 134 includes externally facing male threads 144. The male threads 144 are configured to threadably interface with the female cap threads of the top cap 30 of the reusable fly trap 20 (see FIGS. 2A, 2B, and 2C). On the other hand, as shown in FIG. 3B, the lower section 136 of the tubular column 128 include a bottom opening defined by rim 146. The lower section 136 includes internally facing female threads 148. The female threads 148 are configured to threadably interface with the male threads of a container, such as the bottle 40 of the reusable fly trap (see FIGS. 2A, 2B, and 2C).

For example, FIGS. 2A, 2B, and 2C illustrate an assembled insect trap 100 wherein the top cap 30 of a conventional reusable fly trap 20 has been threadably secured to the threads 144 of the upper section 134 of the tubular column 128, and the lid entrance structure 120 has been removably affixed to the large container 150. Once attached, any insect that enters through the entrance opening 34 of the top cap 30 is able to traverse into the interior cavity 138 (See FIG. 3B) of the tubular column 128.

Also illustrated in FIGS. 2A, 2B, and 2C is the bottle 40 of the conventional reusable fly trap 20 (optionally) threadably secured to the threads 148 of the lower section 136 of the tubular column 128. In an embodiment, an insect lure or attractant can be added to the bottle 40 prior to coupling to the lower section 136. In embodiments that utilize water activated attractants, the attractants can be added to the collection bottle 40 and mixed with a liquid, such as water. As assembled as an insect trap, such as the insect trap 100, the collection bottle 40 is disposed within the interior cavity 152 of the large container 150.

In an alternative embodiment, the tubular column 128 includes other means for removably attaching one or both of the upper section 134 and the lower section 136 to a top cap and a collection bottle, respectively, of a reusable fly trap. In that regard, instead of cooperating threaded connections, the upper and/or lower sections 134, 136 may be configured to be snap fit, elastic/interference fit, configured with twist-lock mechanisms (e.g., bayonet mounts, etc.), slide-lock mechanisms (e.g., dovetails, tongue-and-groove, etc.), etc., in order to removably couple the top cap and the collection bottle of a reusable fly trap to the lid entrance structure. In some embodiments, one or more of these coupling means may be designed to work with the threaded ends of the components 30, 40, of either reusable fly trap 20. Of course, in any of these embodiments, the top cap and collection bottle can be formed with cooperating structure of the coupling means for removable coupling with the lid entrance structure.

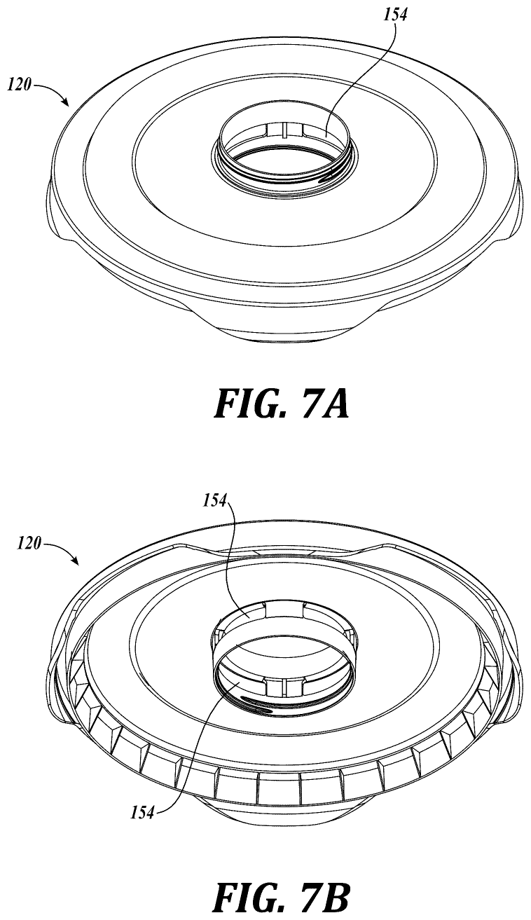

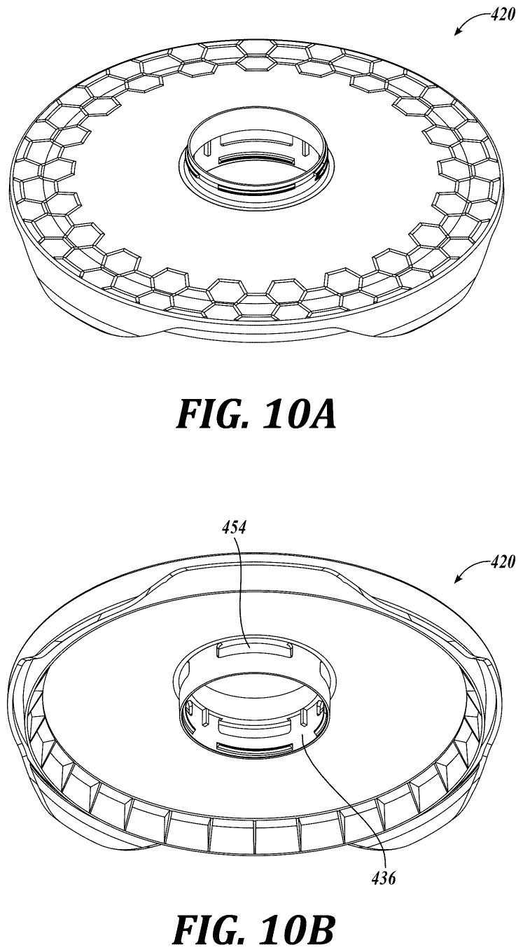

Returning to FIGS. 3A and 3B, the lower section 136 further includes a plurality of openings 154 disposed between the top wall 122 and the threads 148. In the embodiment shown, the plurality (e.g., four) openings 154 are formed in the lower section 136 and are evenly spaced apart. Of course, the openings 154 can have any shape, for example, circular, oval, rectangular, square, polygonal, etc. In the embodiment of FIGS. 3A and 3B, the openings 154 are generally oval in shape. In the embodiments of FIGS. 7A and 7B and FIGS. 10A and 10B, the openings 154 are generally rectangular in shape. As will be described in more detail below, these openings 154 act as side entrances for insects, which have entered into the tubular column 128 of the lid entrance structure 120 via the top cap 30, to traverse into the cavity of the large container 150.

In an embodiment, the large container 150 can be kept dry to collect dry insects/flies for direct or indirect use as feed for domestic birds or other animals. In another embodiment, water can be added to large container to kill the captured insects (flies) by drowning.

In accordance with one or more embodiments of the present disclosure, the lid entrance structure 120 can include one or more additional (optional) features that either aid in attracting insects into the trap 100 or assist in retaining the insects once the insects are inside the trap 100. In that regard, attention is directed to FIGS. 2C, 4A, 4B and 6, where there is shown side entrance members or structures 164 associated (e.g., attached) with the plurality of openings 154 for guiding the insects into the large container 150. In the embodiment shown, the side entrance structures 164 are generally cone-shaped (i.e., funnel-shaped) that allow insects (e.g., flies) to easily traverse from the interior cavity of the tubular column 128 to the large container 150 but do not easily allow the insects to escape the large container 150. In that regard, the side entrance structures 164 include a larger opening 166A on one side (i.e., the side attachable to the tubular column 128) and a smaller opening 166B on the opposite side and facing into the cavity 152 of the large container 150.

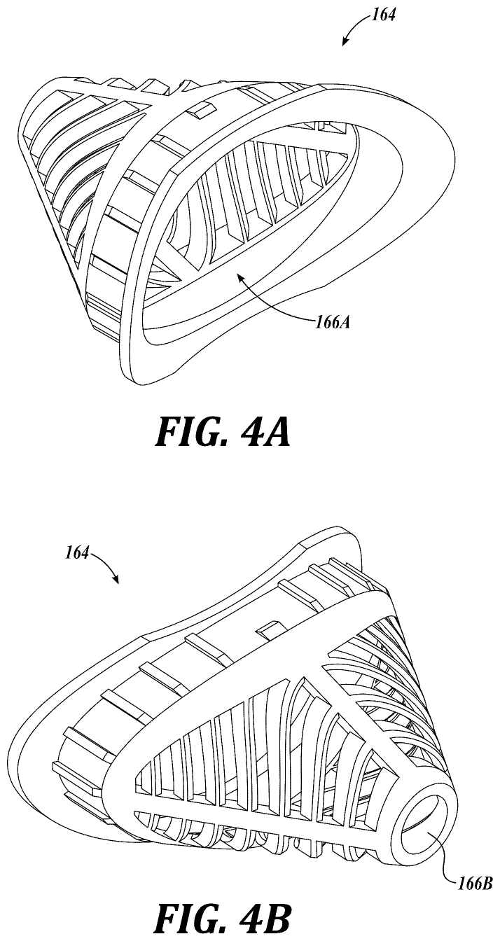

Of course, the optional side entrance structures 164 can vary in size and shape, and in some embodiments, can be formed with small apertures or slots as shown in FIGS. 4A and 4B. The side entrance structures 164 can be attached to the tubular column of the lid entrance structure via any mechanical or chemical techniques known in the art. In an embodiment, the side entrance structures 164 are configured to be snapped in place, as shown in FIG. 2C. In other embodiments, the side entrance structures 164 can be attached via adhesive.

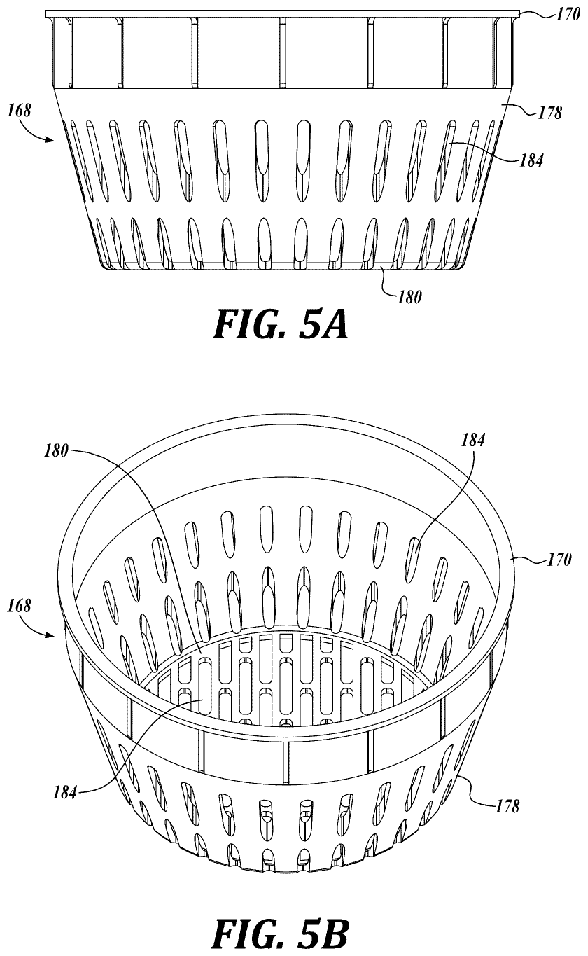

Optionally or additionally, embodiments of the insect trap 100 may be provided with a screen or mesh basket-like member 168 (See FIGS. 2C, 5A, 5B, and 6). The basket-like member 168 is capable of blocking the captured insects (e.g., flies) from entering the lower portion of the collection bottle 40 (and the water-activated attractant), thereby directing the captured insects through the openings 154 (and optional side entrance structures 164) and into the cavity 152 of the large container 150. In the embodiment shown, the basket-like member 168 is configured to nest in the top opening of the collection bottle 40, as shown in FIG. 2C. In that regard, the basket-like member 168 may include an outwardly extending top flange or lip 170 (see FIGS. 5A and 5B) that is supported by the rim of the collection bottle 40 when assembled. In the embodiment shown in FIGS. 5A and 5B, the basket-like member 168 includes a number of spaced-apart orifices or slots 184 in the sidewalls 178 and/or bottom 180 thereof so that the insect attractant can diffuse from the bottle and into the environment surrounding the insect trap. Of course, other structures may be utilized, such as a screen or the like, to block the captured insects (e.g., flies) from entering into the lower portion of the collection bottle 40 (and the water-activated attractant) while also permitting diffusion of insect attractant.

Returning again to FIGS. 2C, 3A and 3B, the lid entrance structure 120 may include other features for retaining the insects inside the insect trap 100. For example, the generally flat or slightly concave top wall 122 of the lid entrance structure 120 may include one or more raised annular rings 174. In the embodiment shown in FIGS. 2C, 3A and 3B, the raised annular ring 174 defines a tunnel 176 near but spaced from the container connection interface 126. The tunnel 176 opens into the interior cavity 152 of the container 150. The tunnel 176 forms a walkway or an area for the insects, once inside the trap 100, to congregate and expire. In an embodiment, the top wall 122 of the lid entrance structure 120 can be at least semi-translucent for allowing light therethrough. Insects attracted to the light will linger in the channel/tunnel and finally expire. The height and/or diameter of the tunnel may vary. Optionally or additionally, a plurality of small holes 182 (FIG. 2A) ranging from about 1 mm to about 5 mm may be added to the lid entrance structure 120, especially on the annular ring 174 to increase overall insect attractant diffusion rates and/or to reduce any condensation inside the container 150.

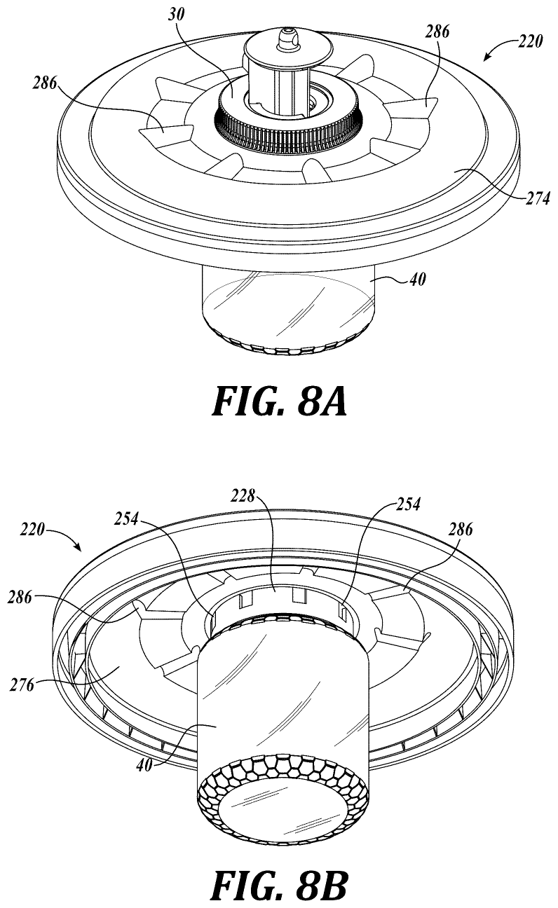

FIGS. 8A and 8B depict another embodiment of the lid entrance structure, generally designated 220, formed in accordance with the present disclosure. The lid entrance structure 220 is substantially identical in structure and operation as the lid entrance structure 120 of FIGS. 3A and 3B except for the differences that will now be described.

As shown in the embodiment of FIGS. 8A and 8B, the lid entrance structure 220 may also include radial channels 286 extending from an area near the tubular column 228 to the annular ring 274. The radial channels 286 are generally aligned with the (rectangular) openings 254 of the tubular column 228 and assist in directing the insects to the annular tunnel 276. In this embodiment, the lid entrance structure 220 may or may not be used with the optional side entrance structures 164, basket-like member 168, the plurality of small holes 182, etc.

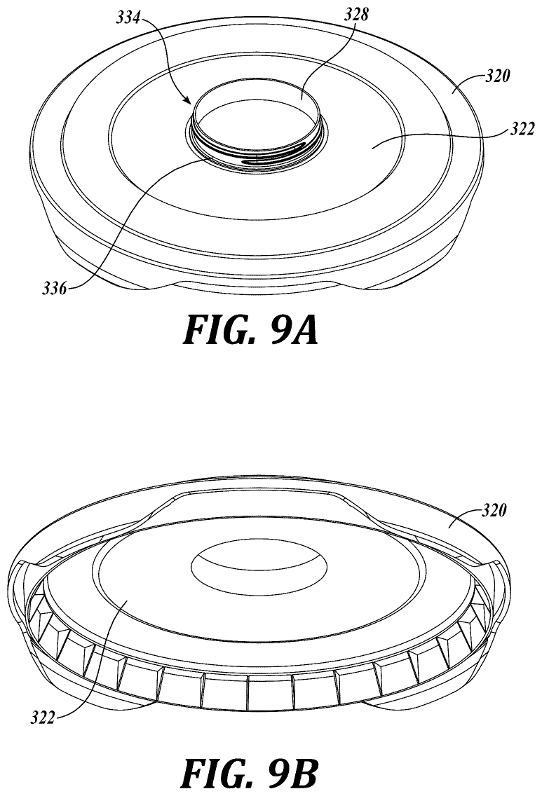

FIGS. 9A and 9B depict another embodiment of the lid entrance structure, generally designated 320, formed in accordance with the present disclosure. The lid entrance structure 320 is substantially identical in structure and operation as the lid entrance structure 120 of FIGS. 3A and 3B except for the differences that will now be described.

As shown in FIG. 9A, the tubular column 328 only includes the upper section 334 with male threads 336 to which a top cap, such as the top cap 30 (see FIG. 2A), can be threadably attached. In other words, as shown in FIG. 9B, the tubular column 328 omits the lower section (see lower section 136 in FIG. 3B) that extends below the top wall (see top wall 122 in FIG. 3B) to which a container bottle may be removably attached. As a result, the container bottle is omitted in this embodiment. In its stead, the water dissolvable attractant pouch or other insect lure can be optionally added to the large container and activated, if necessary, by water. Other features may be also omitted, such as the raised annular ring 174, the plurality of small holes 182, etc. In an embodiment, the top cap 30, the lid entrance structure 320 and (optionally) the water dissolvable attractant pouch can be assembled and sold together for use with a standard 5-gallon bucket.

FIGS. 10A and 10B depict another embodiment of the lid entrance structure, generally designated 420, formed in accordance with the present disclosure. The lid entrance structure 420 is substantially identical in structure and operation as the lid entrance structure 120 of FIGS. 3A and 3B except for the differences that will now be described.

As shown in the embodiment shown in FIGS. 10A and 10B, the lid entrance structure 420 omits the raised annular ring 174 (See FIG. 3A) and the plurality of small holes 182 (See FIG. 2C). In addition, the openings 454 formed in the lower section 436 of the tubular column are rectangular in shape.

The technology set forth in the embodiments described above and illustrated in the FIGURES is not limited to fly traps or for trapping insects of the order Diptera. It should be appreciated that any embodiment described above and illustrated in the FIGURES may be also suitable for trapping other orders of insects, such as insects of the order Hymenoptera, and pestiferous insects from other orders such as beetles (Coleoptera), moths (Lepidoptera) and stink/seed bugs (Heteroptera). Thus, it should be appreciated that the use of the word “fly” in any embodiment described herein could mean any “flying” insect, including but not limited to insects of the order Diptera, unless specifically stated.

Additionally, the lid entrance structure described herein can be configured for use with any reusable insect trap having an insect top, cap or lid and a collection bottle. These reusable insect traps can include but are not limited to reusable insect traps for trapping insects of the orders Hymenoptera, Coleoptera, Lepidoptera, Heteroptera, among others. In some embodiments, suitable adaptors/devices could be added/affixed to the disclosed technology such that a variety of insect/arthropod traps and other devices could be used in conjunction with the disclosed technology.

In the foregoing description, specific details are set forth to provide a thorough understanding of representative embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure.

In the detailed description herein, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. In addition, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments. Thus, it will be appreciated that embodiments of the present disclosure may employ any combination of features described herein. All such combinations or sub-combinations of features are within the scope of the present disclosure.

Throughout this specification, terms of art may be used. These terms are to take on their ordinary meaning in the art from which they come, unless specifically defined herein or the context of their use would clearly suggest otherwise.

The drawings in the FIGURES are not to scale. Similar elements are generally denoted by similar references in the FIGURES. For the purposes of this disclosure, the same or similar elements may bear the same references. Furthermore, the presence of reference numbers or letters in the drawings cannot be considered limiting, even when such numbers or letters are indicated in the claims.

The term “unitary” is used in the present application to denote that one or more embodiments of the lid entrance structure are made as a single piece during manufacturing. Thus, a unitary component has a monolithic construction for the entire component and is different from a component that has been made from a plurality of component pieces that have been joined together to form a single component. Of course, embodiments of the lid entrance structure can be made from a plurality of discrete components and coupled together using any known techniques.

The present application may reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The terms “about,” “approximately,” “near,” etc., mean plus or minus 5% of the stated value. For the purposes of the present disclosure, the phrase “at least one of A and B” is equivalent to “A and/or B” or vice versa, namely “A” alone, “B” alone or “A and B.”. Similarly, the phrase “at least one of A, B, and C,” for example, means (A), (B), (C), (A and B), (A and C), (B and C), or (A, B, and C), including all further possible permutations when greater than three elements are listed.

Where a range of values is provided, it is understood that each intervening value, to the tenth of the unit of the lower limit (unless the context clearly dictates otherwise), between the upper and lower limit of that range, and any other stated or intervening value in that stated range, is encompassed within the disclosure. The upper and lower limits of these smaller ranges may independently be included in the smaller ranges and are also encompassed within the disclosure, subject to any specifically excluded limit in the stated range. While the stated range includes one or both of the limits, ranges excluding either or both of those included limits are also included in the disclosure.

The principles, representative embodiments, and modes of operation of the present disclosure have been described in the foregoing description. However, aspects of the present disclosure which are intended to be protected are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure, as claimed.

The embodiments of the invention in which an exclusive property or privilege is claimed are defined as follows:

1. A lid entrance structure for use with a container and a reusable insect trap, the reusable insect trap having an insect trap top and a bottle, the lid entrance structure comprising:
a top wall having an outer periphery;
a tubular column having an upper section extending outwardly from the top wall and a lower section extending outwardly from the top wall in a direction opposite of the upper section, wherein the upper section includes means for removably coupling the insect trap top of the reusable insect trap to the upper section and the lower section includes means for removably coupling the bottle of the reusable insect trap to the lower section; and
a container connection interface extending around at least one section of the outer periphery of the top wall, the container connection interface configured to be removably securable to the container, wherein a volume of the container is larger than a volume of the bottle.

2. The lid entrance structure of claim 1, wherein the lower section further includes one or more openings disposed in the sidewall of the tubular column.

3. The lid entrance structure of claim 1, wherein the volume of the container is more than three times the volume of the bottle.

4. The lid entrance structure of claim 3, wherein the volume of the container is more than ten times the volume of the bottle.

5. The lid entrance structure of claim 3, wherein the container is a standard 5-gallon bucket.

6. The lid entrance structure of claim 1, wherein the top wall includes one or more raised annular rings.

7. The lid entrance structure of claim 6, further comprising a plurality of holes formed in the one or more raised annular rings.

8. The lid entrance structure of claim 7, wherein the top wall is at least semi-translucent for allowing light therethrough.

9. A lid entrance structure, comprising:
a top wall having an outer periphery;
a centrally disposed, tubular column having an upper section extending outwardly from the top wall, the upper section configured to be removably coupled to a fly trap lid of a reusable fly trap; and
a container connection interface extending in one or more sections around the outer periphery of the top wall, the container connection interface configured to be removably affixable to a container.

10. The lid entrance structure of claim 9, wherein the tubular column also has a lower section extending outwardly from the top wall in a direction opposite of the upper section, the lower section configured to be removably coupled to a bottle, the container being at least five times by volume larger than the bottle.

11. The lid entrance structure of claim 10, wherein the bottle is part of the reusable fly trap.

12. The lid entrance structure of claim 9, wherein the container is a standard 5-gallon bucket.

13. An insect trap, comprising:
a reusable fly trap having a fly trap cap and a collection bottle,
a container that is at least five times by volume larger than the collection bottle; and
an insect trap lid including:
a top wall having an outer periphery;
a tubular column having an upper section extending outwardly from the top wall and a lower section extending outwardly from the top wall in a direction opposite of the upper section, the upper section including means for removably coupling the fly trap cap to the upper section and the lower section including means for removably coupling the collection bottle to the lower section; and
a container connection interface extending around at least one section of the outer periphery of the top wall, the container connection interface configured to be removably secured to the container.

14. The insect trap of claim 13, wherein the lower section of the tubular column further includes at least one opening disposed in the sidewall of the tubular column.

15. The insect trap of claim 14, further including at least one funnel-shaped side entrance member, the at least one funnel-shaped side entrance member coupled to the lower section of the tubular column at each location of the at least one opening.

16. The insect trap of claim 14, further comprising a basket supported by the collection bottle.

17. The insect trap of claim 16, further comprising a water activated insect attractant contained in the collection bottle.

18. The insect trap of claim 13, further comprising means for retaining insects within the insect trap.
